(19) United States
(12) Patent Application Publication
(10) Pub. No.: US 2006/0120558 A1
(43) Pub. Date: Jun. 8, 2006

(54) System and method for lossless data hiding using the integer wavelet transform

(76) Inventors: Yun-Qing Shi, Millburn, NJ (US); Guorong Xuan, Shanghai (CN)

Correspondence Address: KAPLAN GILMAN GIBSON & DERNIER L.L.P., 900 ROUTE 9 NORTH, WOODBRIDGE, NJ, 07095, US

(21) Appl. No.: 11/252,155

(22) Filed: Oct. 17, 2005

Related U.S. Application Data
(60) Provisional application No. 60/620,494, filed on Oct. 20, 2004.

(51) Int. Cl. G06K 9/36; G06K 9/00

(52) U.S. Cl. 382/100; 382/232; 382/248

(57) ABSTRACT

A system and method are disclosed which may include subjecting an original, pixel domain image to an Integer Wavelet Transform (IWT) to obtain a first matrix of IWT coefficients; multiplying selected ones of the IWT coefficients by two; and embedding a data bit in a LSB (Least Significant Bit) position of each selected coefficient, thereby providing a marked image.

### CROSS-REFERENCE TO RELATED APPLICATIONS

This application claims the benefit of U.S. Provisional Patent Application Ser. No. 60/620,494, filed Oct. 20, 2004, entitled “INVERTIBLE DATA HIDING BASED ON INTEGER WAVELET TRANSFORM AND COMPANDING TECHNIQUE”, the entire disclosure of which is hereby incorporated herein by reference.

### BACKGROUND OF THE INVENTION

Advancements in information technology have made it possible to transmit large quantities of data via the Internet. However, these advancements also provide opportunities for hackers to steal valuable information. Therefore, security has become an important issue. This application includes a numbered list of reference documents at the end hereof. For the sake of brevity, these documents are referred to herein using the reference document number within square brackets.

Digital data hiding can hide sensitive information into multimedia for covert communications. Most multimedia data hiding techniques distort the cover media by inserting hidden data therein. Moreover, in some cases, the effects on the cover media may not be fully reversible upon extraction of the hidden data. Although the distortion is often small and imperceptible to human visual systems (HVS), the irreversibility is unacceptable for certain sensitive applications, such as legal and medical imaging. For these applications, lossless data hiding is desirable to extract the embedded data and to recover the original cover media without any distortion. About twenty lossless data hiding methods have been developed. For a survey, readers are referred to Y. Q. Shi, Z. Ni, D. Zou, C. Liang and G. Xuan, “Lossless data hiding: Fundamentals, algorithms and applications,” Proceedings of IEEE International Symposium on Circuits and Systems, vol. II, pp. 33-36, Vancouver, Canada, May 2004; Y. Q. Shi, “Reversible data hiding,” Proceedings of International Workshop on Digital Watermarking, Seoul, Korea, Oct. 1 to Nov. 2, 2004. Ni et al. have proposed a histogram-manipulation based lossless data hiding scheme. See Z. Ni, Y. Q. Shi, N. Ansari and W. Su, “Reversible data hiding,” Proceedings of IEEE International Symposium on Circuits and Systems, Bangkok, Thailand, May 2003. Leest et al., A. Leest, M. Veen, and F. Bruekers, “Reversible image watermarking,” Proc. of IEEE ICIP, vol. 2, pp. 731-734, September 2003, proposed a reversible image watermarking algorithm using the gaps technique. J. Tian, “Reversible data embedding using a difference expansion,” IEEE Transactions on Circuits and Systems for Video Technology, August (2003) (890-896) embeds data using a difference expansion technique. Xuan et al. proposed the reversible data hiding algorithms carried out in the integer wavelet transform (IWT) domain. This method, by G. Xuan, J. Zhu, J. Chen, Y. Q. Shi, Z. Ni and W. Su, “Distortionless data hiding based on integer wavelet transform,” IEE Electronics Letters, December (2002) 1646-1648, losslessly compresses one or more middle bit-planes to save space for data embedding. Another method by G. Xuan, Y. Q. Shi, Z. Ni, “Lossless data hiding using integer wavelet transform and spread spectrum,” IEEE International Workshop on Multimedia Signal Processing, Siena, Italy, September 2004, applies a spread-spectrum technique to embed data in high frequency IWT coefficients. However, there is a need in the art for a simpler and more efficient way to embed information within image data.

### SUMMARY OF THE INVENTION

According to one aspect, the invention provides a method which may include a method that may include subjecting an original, pixel domain image to an Integer Wavelet Transform (IWT) to obtain a first matrix of IWT coefficients; multiplying selected ones of said IWT coefficients by two; and embedding a data bit in a LSB (Least Significant Bit) position of each said selected coefficient, thereby providing a marked image.

Other aspects, features, advantages, etc. will become apparent to one skilled in the art when the description of the preferred embodiments of the invention herein is taken in conjunction with the accompanying drawings.

### BRIEF DESCRIPTION OF THE DRAWING

For the purposes of illustrating the various aspects of the invention, there are shown in the drawings forms that are presently preferred, it being understood, however, that the invention is not limited to the precise arrangements and instrumentalities shown.

FIG. 1 is a block diagram of a method for embedding data into an image and extracting the embedded data therefrom in accordance with one or more embodiments of the present invention;

FIG. 2 is a block diagram for a method 200 of data hiding that may embed data using companding (compression and expansion), data embedding, and/or histogram modification in accordance with one or more embodiments of the present invention;

FIG. 3A is a block diagram showing a plurality of wavelet sub-bands within the integer wavelet domain;

FIG. 3B is a plot of the Laplacian distribution function

$$f ( x ) = \frac{λ}{2} {ⅇ}^{- λ \vert x \vert} ,$$

with λ=2, which distribution is similar to that found for the values of coefficients of high frequency coefficients in the integer wavelet transform domain;

FIG. 3C includes plots of wavelet coefficient distribution functions among high-frequency sub-bands HH1, HL1, and LH1 of the “Lena” image of FIG. 5;

FIG. 4 is a plot of a compression function C(x) as a function of x which may be used in accordance with one or more embodiments of the present invention;

FIG. 5 shows a plurality of test images into which data may be embedded employing a method in accordance with one or more embodiments of the present invention;

FIG. 6 is a plot of PSNR (Peak Signal to Noise Ratio) against payload size for one method in accordance with one or more embodiments of the present invention and for a plurality of prior art approaches;

FIG. 7A shows a 512-pixel by 512-pixel version of the “Lena” image having 157,286 bits (0.6 bits per pixel) stored therein in accordance with one or more embodiments of the present invention;

FIG. 7B shows a 512-pixel by 512-pixel version of the “Lena” image having 340,787 bits (1.3 bits per pixel) stored therein in accordance with one or more embodiments of the present invention;

FIG. 8 is a flow diagram of a method for embedding data in an image in accordance with one or more embodiments of the present invention;

FIG. 9 is a flow diagram of a method for extracting data from an image in accordance with one or more embodiments of the present invention;

FIG. 10 is a plot of PSNR against payload size for an image (the Lena image) into which data has been embedded using a method in accordance with one or more embodiments of the present invention and for a plurality of prior art approaches;

FIG. 11A shows an original version of the Lena image;

FIG. 11B shows a version of the Lena image after one occurrence of data embedding with a resulting payload of 0.7 bpp (bits per pixel) and a PNSR of 37.46, in accordance with one or more embodiments of the present invention;

FIG. 11C shows a version of the Lena image after two occurrences of data embedding with a resulting payload of 1.3 bpp (bits per pixel) and a PNSR of 31.1, in accordance with one or more embodiments of the present invention;

FIG. 11D shows a version of the Lena image after three occurrences of data embedding with a resulting payload of 1.7 bpp (bits per pixel) and a PNSR of 25.7, in accordance with one or more embodiments of the present invention;

FIG. 12 illustrates histograms of (a) an original image suitable for modification in accordance with one or more embodiments of the present invention and (b) a histogram of the image shown in (a) which has been modified in accordance with one or more embodiments of the present invention;

FIG. 13A illustrates a simple example of an original image suitable for histogram modification in accordance with one or more embodiments of the present invention;

FIG. 13B illustrates a version of the image shown in FIG. 13A that has been modified in accordance with one or more embodiments of the present invention;

FIG. 14A shows image data corresponding to the original image shown in FIG. 13A;

FIG. 14B shows image data corresponding to the modified image shown in FIG. 13B;

FIG. 15 is a table of histogram data of the image of FIG. 3 before and after modification in accordance with one or more embodiments of the present invention;

FIG. 16 is a table of bookkeeping data associated with the modification of the histogram of the image of FIG. 2A suitable for preservation by a method in accordance with one or more embodiments of the present invention;

FIG. 17 is a listing of a histogram modification algorithm in accordance with one or more embodiments of the present invention; and

FIG. 18 is a block diagram of a computing system adaptable for use with one or more embodiments of the present invention.

### DETAILED DESCRIPTION OF THE PREFERRED EMBODIMENTS

Herein, the term “hidden data” generally corresponds to the term “embedded data.” Embedded data may include “payload data” and/or “overhead data.” Herein, the term “overhead data” may include “bookkeeping data.” Herein, the terms “frequency band” and frequency sub-band” correspond to the term “wavelet sub-band.”

Herein, “payload data” (which may also be referred to herein as “a watermark signal”) is information which may form part of a coherent message, which may be embedded in an image, thereby providing a marked image. This payload data may subsequently be extracted from the marked image, thereby partially or completely restoring the condition of the original image. The referenced “partial” restoration may occur where other data, such as overhead data, is still embedded in the image, and/or where histogram modification of the original occurred and has not yet been reversed.

Thus, there may be an unencoded form of the payload data which exists prior to it being embedded into an image and an encoded form of the payload data which exists while the data is embedded in the image. Once embedded into an image, the watermark signal is preferably recoverable by a payload data extraction method in accordance with one or more embodiments of the present invention.

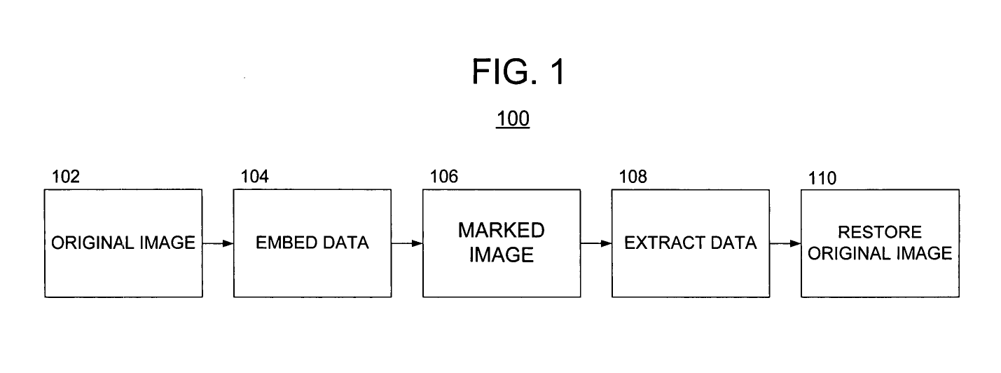

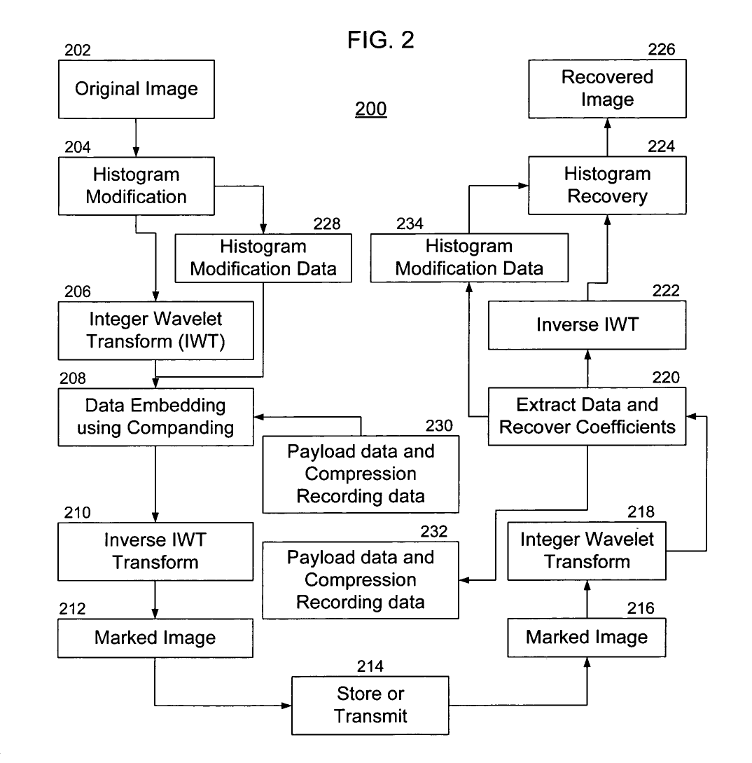

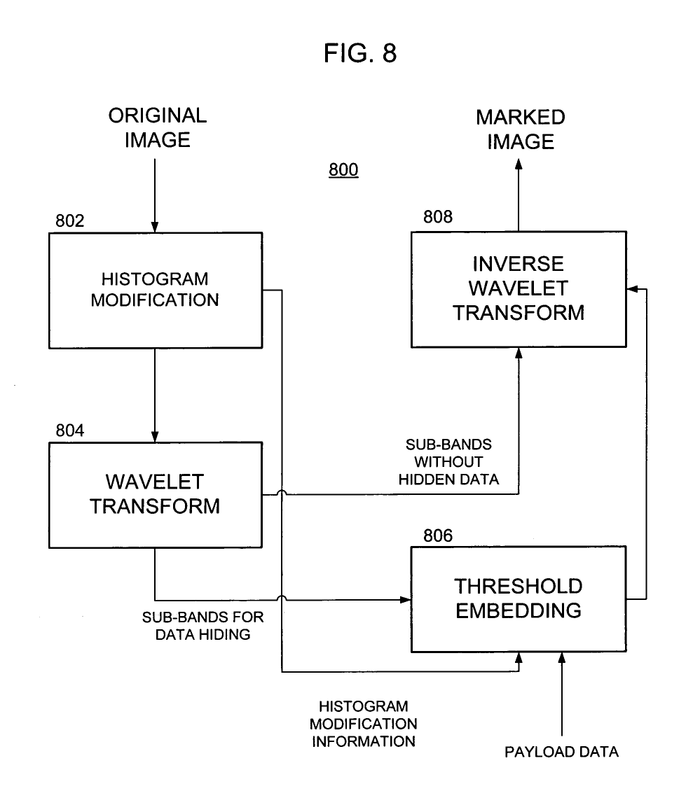

FIG. 1 is a block diagram of a method for embedding data into an image and extracting the embedded data therefrom in accordance with one or more embodiments of the present invention. In one or more embodiments, data may be embedded (step 104) in original image 102 using the companding embodiment shown in FIG. 2 and/or the threshold embedding embodiment shown in FIG. 8 to produce marked image 106. Thereafter, the embedded data may be extracted (step 108) to restore (step 110) original image 102 using the companding method of FIG. 2 and/or the extraction portion of the threshold embedding method, shown in FIG. 9.

In one or more embodiments, embedding step 104 may include subjecting an original, pixel domain image to an Integer Wavelet Transform (IWT) to obtain a matrix of IWT coefficients. A more detailed description of the Integer Wavelet Transform may be found following the discussion of FIG. 1, below. Thereafter, a selection of the IWT coefficients may multiplied by two, thereby shifting the binary representation of the multiplied coefficient to the left by one bit position. This shifting preferably leaves the LSB (Least Significant Bit) position empty, thereby providing an opportunity for embedding a data bit therein. Thereafter, a data bit may be embedded in the LSB position of each coefficient that was multiplied by two. Performing this embedding (step 104) for all of the selected coefficients preferably provides marked image 106.

In one or more embodiments, the extraction step 108 may include subjecting a marked pixel-domain image to an Integer Wavelet Transform to obtain a matrix of IWT coefficients. Thereafter, IWT coefficients within the matrix that contain embedded payload data are preferably identified using one or more of the methods disclosed herein. It will be recalled that coefficients with embedded data preferably have an embedded data bit in the LSB position thereof. Accordingly, a data bit is preferably extracted (step 108) from the LSB position of each of the coefficients that was identified as having data embedded therein. Preferably, to restore the values of the identified coefficients to what they were prior to the embedding of data therein, the identified coefficients are preferably divided by two. Upon performing this division on all of the coefficients that had data embedded therein, the image is preferably restored (step 110) to its original condition.

Integer Wavelet Transform

The Integer Wavelet Transform is widely applied to many different tasks in image processing. Since the wavelet transform coefficients are highly decorrelated, and because the wavelet transform is consistent with one or more features of the human visual system (HVS), the wavelet transform is also widely applied to image data hiding. Evidence indicates that slight modification of wavelet transform coefficients in high frequency subbands is difficult to perceive. Hence, in one or more embodiments disclosed herein, data is embedded into high-frequency wavelet coefficients.

To recover the original image losslessly, a reversible wavelet transform is preferably employed. Hence, one or more embodiments of the present invention employ the integer wavelet transformation which maps integer to integer and which can reconstruct the original image from the transformed image without distortion. Various wavelet families could be employed for the reversible embedding scheme described herein. However, through extensive experimental comparison, it has been discovered that CDF(2,2) (where CDF refers to “Cohen-Daubechies-Feauveau”) is better than other wavelet families in terms of data embedding capacity and the visual quality of the marked images. In addition, it is noted that the CDF(2,2) format has been adopted by the JPEG2000 standard.

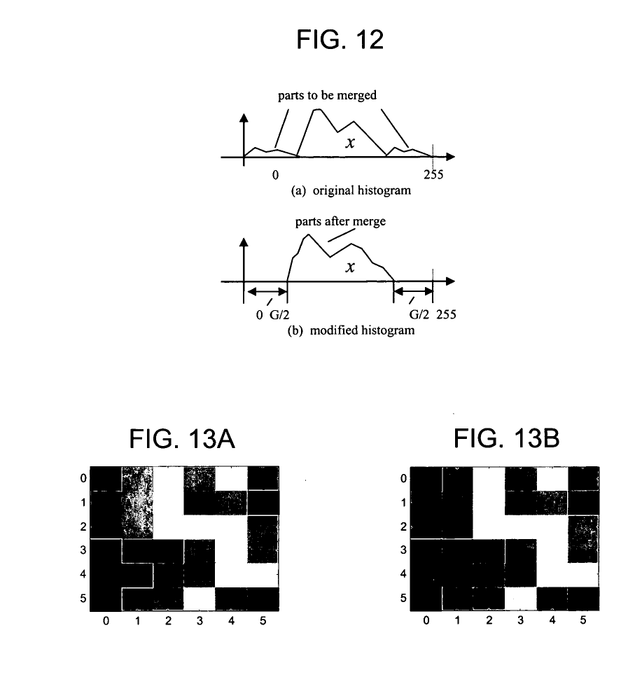

FIG. 2 is a block diagram for a method 200 of data hiding that may embed data using companding (compression and expansion), data embedding, and/or histogram modification in accordance with one or more embodiments of the present invention. In this section, the various steps of FIG. 2 are discussed in sequence. Because of the extent of detail provided in connection with the application of companding in this disclosure, an extensive discussion of companding follows the initial discussion of FIG. 2. Separately, additional detail with regard to histogram modification is provided in connection with FIGS. 12-17 after the discussion of the threshold embedding embodiment.

In one or more embodiments, an original image 202 is preferably provided. At step 204, histogram modification may be performed on the original image to prevent underflow and/or overflow of pixel values upon performing the inverse integer wavelet transform in step 210. Histogram modification is described in greater detail later in this disclosure and is therefore not described in detail in this section. Histogram modification data 228 may be preserved as part of step 204 to enable histogram recovery in step 224. Herein, histogram modification data may also be referred to as “bookkeeping data.”

At step 206, an integer wavelet transform is preferably performed on the original pixel-domain image 202. At step 208, payload data 230 are preferably embedded into the IWT coefficients. The data embedding method discussed above in connection with FIG. 1 may be employed for this purpose. Moreover, a compression function may be applied to the IWT coefficients generated by the IWT transform of step 206 to prevent overflow and/or underflow within the wavelet domain, thereby providing compressed IWT coefficients. Compression recording data (block 230) describing details of the application of the compression function to various IWT coefficients may be embedded into the IWT coefficients in step 208 to enable accurate recovery of the original (“expanded” or “uncompressed”) IWT coefficients upon performing data extraction (step 220). The details of the application of the compression function to the IWT coefficients and of the data embedding algorithm are extensive and are therefore provided in the companding discussion following the discussion of the numbered steps shown in FIG. 2.

At step 210, an inverse IWT transform may be performed to convert the IWT coefficients that may have undergone compression and data embedding in step 208 into a pixel-domain marked image 212. The marked image 212 may be securely stored and/or transmitted (step 214) as desired. Preferably, marked image 212 provides secure protection against inadvertent disclosure of the payload data and/or other data embedded therein to unauthorized persons or entities, since the specific algorithms disclosed herein are preferably needed to extract such payload data and other data (such as compression recording data and histogram modification data).

The remainder of FIG. 2 is directed to the extraction of embedded payload data from the marked image 212 and to the provision of recovered image 226 which is preferably identical to original image 202. This portion of the method of FIG. 2 includes steps 216 through 224, the discussion of which follows. As with the case of compression and embedding, discussed above, the extensive details of the data extraction and coefficient recovery operations, which may include coefficient expansion (the reverse of “compression”) (step 220) are included in the companding section that follows the discussion of steps 216-224.

In one or more embodiments, marked image 216 may be subjected to an integer wavelet transform in step 218. At step 220, a data extraction algorithm may be applied to the IWT coefficients to extract the embedded payload data and the compression recording data 234. In the compression process which forms part of step 208, compression recording data preferably preserves information describing instances where compression results in a many-to-one mapping of pre-compression coefficient values to post-compression values. In the expansion process (which may form part of step 220), this compression recording data preferably enables the method to accurately identify which original coefficient value, among the “many” (usually two) coefficient values that could have mapped to a single compressed coefficient value, will be restored to the post-expansion IWT coefficient. Thus, the original IWT coefficient values (those existing prior to step 208 in the embedding half of method 200) may be accurately restored. Separately, histogram modification data 234, which were preferably embedded into the IWT coefficients in step 208, may be extracted for later use within method 200.

In one or more embodiments, an inverse integer wavelet transform (step 222) may be performed on the IWT coefficients resulting from the operations of step 220, which preferably provides a histogram-modified pixel domain image that preferably matches the condition of the image in existence in between steps 204 and 206 of method 200. Preferably, at step 224, histogram recovery is performed using extracted histogram modification data 234, thereby providing recovered image 226. Recovered image is preferably identical to original image 202.

In the following, additional detail is provided with respect to certain operations described above.

### Companding Embodiment

Companding, the processing pair of compression and expansion, is a technique utilized to implement non-uniform quantization in speech communications in order to achieve high signal-and-noise ratio (SNR), where the noise is usually quantization noise. Specifically, this procedure first compresses a signal and then expands it. Uniform quantization is applied after the compression and before the expansion. As a result, with the companding and uniform quantization, non-uniform quantization is equivalently performed. That is, the signal of small magnitude is quantized with a relatively small quantization step while the signal of large magnitude is quantized with a relatively large quantization step so that the SNR through quantization is reduced as compared with using uniform quantization. Hence, the quantizing process is more accurate where needed. After the expansion is applied to the compressed signal, the expanded signal is expected to be close to the original signal. In the ideal situation, this companding operation can be expressed as
E(C(x))=x (1)

where C stands for the compression function, and E for the expanding function. Preferably, if this assumption is satisfied, this technique can be successfully applied to the invertible data hiding.

Companding Technique Used for Invertible Data Hiding

A simple realization is as follows:
(1) Compression function C is applied to the original signal x to produce a new signal y=C(x), which is the compressed signal. In one or more embodiments herein, the compression function described in this section may be applied to IWT coefficients as discussed above in connection with step 208 of FIG. 2. Assume the binary expression of y, i.e., the natural binary code of y, is p₁p₂ . . . pₙ where pᵢε{0,1}.
(2) A bit b ε{0,1} is appended after the least significant bit (LSB) of y . In this way, y becomes y′=p₁p₂ . . . pₙb, which means y′=2×y+b. For generality, we use P to express this appending operation, i.e., y′=P(y) . Thus, for the embedding operation discussed in connection with step 208 of FIG. 2, data may be embedded into the LSB position of IWT coefficients by first multiplying the IWT coefficients by two, effectively shifting the original bit values of such coefficients to the left by one bit position. Thereafter, the bit to be embedded in each IWT coefficient may be inserted into the LSB position of each IWT coefficient that is preferably left empty by the multiplication/shifting operation. This process effectively “appends” the embedded bit after the shifted IWT coefficient bits.
(3) If y′≈x, then the modification of the signal will be small and will hardly be perceived.
(4) In the hidden data extraction stage, we only need to extract the LSB bit of the modified compressed signal y′, which means b=LSB(y′), and recover the compressed signal

$$y = \frac{{y}^{′}}{2} .$$

This formula may be applied as part of the data extraction operation of step 220 of FIG. 2.
(5) After obtaining the compressed signal y, we can recover the original signal by applying expansion, i.e., x=E(y). This “expansion” portion of the companding method preferably reverses the compression portion of the companding method (which may form part of step 208) and may be performed as part of step 220 of the method shown in FIG. 2.

From the above steps, we can see that the functions C, E and P should satisfy the following two conditions:
Condition (A): E(C(x))=x,
Condition (B): P(C(x))≈x, and the P(C(x)) is within the range of the original signal x, which means that neither overflow nor underflow will take place.

In dealing with digital signals, however, the above two conditions are difficult to completely satisfy due to the nature of digitization. This is because the quantized companding functions C_{Q} and E_{Q} may be utilized instead, where
C_{Q}=Q(C), E_{Q}=Q(E) (2)
and Q denotes the quantization function. Obviously, right now for some signal x, we may have
E_{Q}(C_{Q}(x))≠x (3)
namely the difference (error) value is
r=E_{Q}(C_{Q}(x))−x≠0. (4)

Hence in order to recover the original signal x, we must record the difference value r. This is to say that the difference value r and the payload data may both be embedded into the host signal x as overhead data (compression recording data) and payload data, respectively.

Selection of Compression Function in the Companding Technique

Through the analysis of companding function, we find that if Condition (B) were not considered, then any one-to-one mapping function F can be utilized as a compression function. For example, the simplest linear function F(x)=x can be considered to be a compression function. However, if multiple x values map to a single value of y, it will not be straightforward to find the x value corresponding to a given y value. This function can, however, still be used as a compression function under the condition that some payload may be sacrificed to make room for data to record the multiplicity, and to resolve any uncertainty regarding the value of x upon applying the expansion function.

For example, if x₁, x₂ are compressed to the same y₀, in order to express this mapping relationship, we need to use one bit to record which x is mapped to y₀, say, bit 0 to indicate x₁ and bit 1 to indicate x₂. These overhead data, used for compression recording purposes, may also be embedded into the TWT coefficients.

For speech signals, the following compression and expanding functions may be used:

$$C ( x ) = \frac{1}{2} \sqrt{x} , E ( x ) = {( 2 x )}^{2} \qquad ( 5 )$$

in which x is normalized to the range [0,1].

In practice, it is difficult to find a function that satisfies both one-to-one mapping and Condition (B). For example, the linear function F(x)=x does not satisfy Condition (B) if the input signal x is large, since y′ is almost twice the value of x, and y′ may encounter either an overflow or underflow problem.

From the histogram of many images, it is observed that image data are different from speech signals in that the former often have large magnitude while the latter are generally of small magnitude. Therefore, for digital images, the above functions expressed in (5) are not suitable for companding. See B. Yang, M. Schmucker, W. Funk, C. Busch, and S. Sun, “Integer DCT-based reversible watermarking for images using companding technique,” Proceedings of SPIE Vol. #5306, 5306-41, January 2004. This is because of the differing nature of aural and visual signals. The selection of compression and expanding functions plays a key role when used in the invertible data hiding.

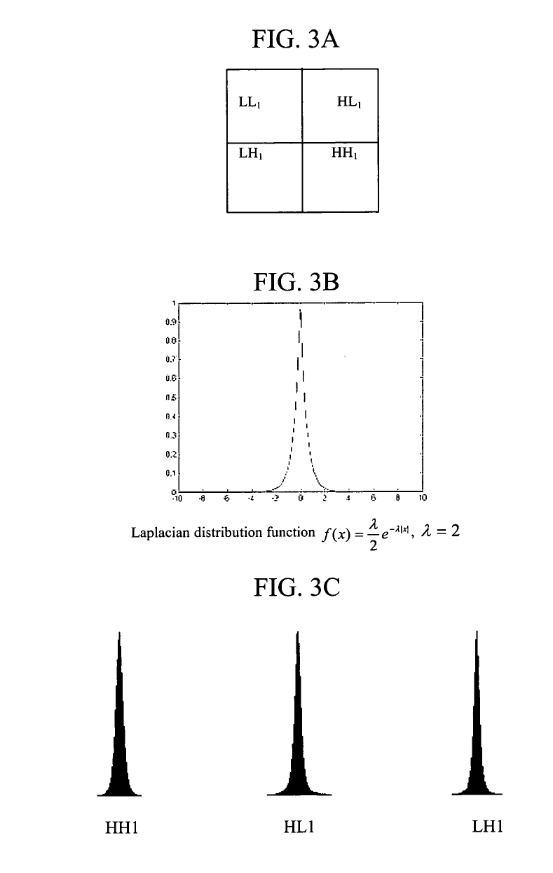

For most images, the values of high-frequency IWT coefficients fall within a Laplacian-like distribution. An example of a Laplacian distribution function is shown in FIG. 3B. Some practical examples of distributions of coefficient values for three IWT frequency sub-bands are shown in FIG. 3C. Clearly, the following two features exist in the distribution.

First, most high frequency IWT coefficients are very small in magnitude. It is then convenient to select the compression function. For example, the linear function F(x)=x may be considered to be a compression function since, even though y′ is twice the value of x, the coefficients of y′ are still within the allowed range of value of the high frequency IWT coefficients.

Second, there are still some large-magnitude high frequency IWT coefficients. For these large coefficients, the selected compression function selection may violate the restriction of Condition (B). In this case, the linear function F(x)=x may not serve as an effective compression function.

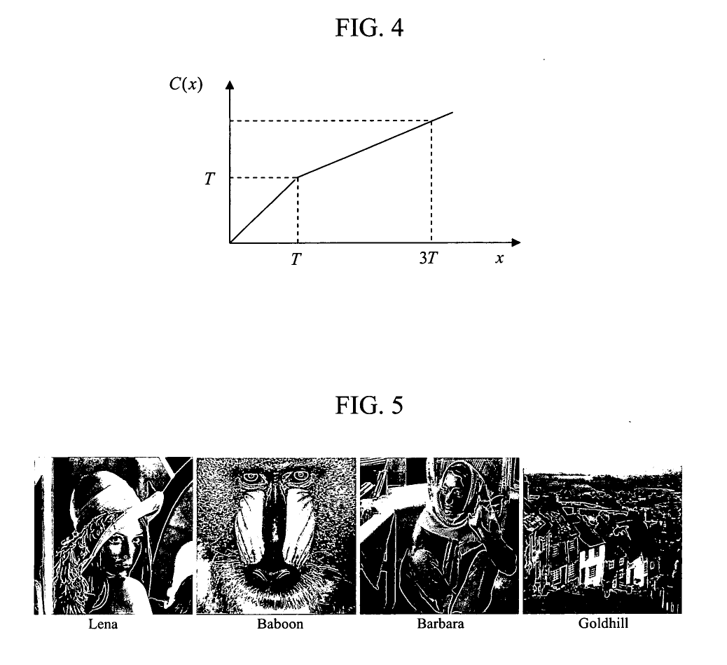

Considering the above two different situations, we propose to adopt the following piecewise linear function as the compression function.

$$C ( x ) = \{ \begin{matrix}x , & as & \vert x \vert < T \\ sign ( x ) \cdot ( \frac{\vert x \vert - T}{2} + T ) , & as & \vert x \vert \geq T\end{matrix} \} \qquad ( 6 )$$

where T is a pre-defined threshold. A plot of C(x) as a function of x is depicted in FIG. 4.

In actual realization, however, as discussed above, the compression function in quantized version is preferably employed, which is:

$$Q ( C ) = {C}_{Q} ( x ) = \{ \begin{matrix}x , & as & \vert x \vert < T \\ sign ( x ) \cdot ( ⌊ \frac{\vert x \vert - T}{2} ⌋ + T ) , & as & \vert x \vert \geq T\end{matrix} \} \qquad ( 7 )$$

The meaning of the symbol └ ┘ in equation (7) is explained as follows: └x┘ takes the largest integer value that is smaller than x. It can be shown from the above equation that when |x|≧T, x, more than one x value will be compressed to the same y value. The first possibility is that x and (x+1) will compress to the same value. Alternatively, x and (x−1) could compress to the same value. Referring to equations (4) and (7), where r>0, the pre-compression value is (x+1); where r<0, the pre-compression value is (x−1); and where r=0, the pre-compression value is simply “x”. Hence, as discussed earlier herein, the identification of which value among x and (x+1), or x and (x−1), is mapped to a particular Y value is preferably recorded, and this recording data (referred to herein as compression recording data) is preferably stored as overhead data into the wavelet coefficients. Preferably, storing the compression recording data enables the reversal of the above-mentioned mappings of multiple x values to a single y value in a subsequent expanding operation. Specifically, in the expanding operation, a single y value will be mapped to one of several possible x values based on equation (7). Preferably, the combination of the expanding function and the stored compression recording data can identify a unique x value for every y value subject to the expanding operation (expansion function).

The value of T may be selected by a human operator so as to achieve a desired compromise between data embedding payload and quality of the marked image. Alternatively, a software program may be executed to determine the value of T. Moreover, a software program may be run to determine data embedding payloads and numerical indicia of marked image quality for various values of T. Thereafter, a human operator may select a value of T based on these computer-generated data. When T is small, the changes in value of the coefficients are small, and good visual quality of marked image may be achieved. When T is large, a larger payload can be achieved. Preferably, both the desired quantity of payload data and the resulting quality of the image that contains the embedded data are factors in deciding the value of T to be used in the embedding process.

Values of T for various known images are shown below.

TABLE 1
T-value selection and corresponding payload for Lena image.
(The unit bpp stands for bit per pixel.)

| | data | | |
|---|---|---|---|
| | T | | |
| Image | T = 4 | T = 6 | T = 8 |
| Lena | 0.50 bpp | 0.62 bpp | 0.68 bpp |

TABLE 2
More examples on the relationship between T-value and the resultant
payload. (All images are of 512 × 512 × 8)

| | T | | | | | | | |
|---|---|---|---|---|---|---|---|---|
| | T = 1 | T = 2 | T = 3 | T = 4 | T = 5 | T = 6 | T = 7 | T = 8 |
| Image | (bpp) | (bpp) | (bpp) | (bpp) | (bpp) | (bpp) | (bpp) | (bpp) |
| Airplane | 0.14 | 0.36 | 0.50 | 0.58 | 0.62 | 0.65 | 0.67 | 0.69 |
| Baboon | 0.03 | 0.10 | 0.16 | 0.22 | 0.27 | 0.32 | 0.36 | 0.40 |
| Lena | 0.09 | 0.26 | 0.40 | 0.50 | 0.57 | 0.62 | 0.65 | 0.68 |
| Barbara | 0.09 | 0.25 | 0.38 | 0.46 | 0.51 | 0.55 | 0.57 | 0.59 |
| Fingerprint | 0.09 | 0.24 | 0.36 | 0.45 | 0.51 | 0.56 | 0.59 | 0.62 |
| Goldhill | 0.07 | 0.21 | 0.32 | 0.42 | 0.49 | 0.55 | 0.59 | 0.62 |
| Elaine | 0.06 | 0.17 | 0.26 | 0.34 | 0.41 | 0.47 | 0.52 | 0.56 |
| Peppers | 0.07 | 0.21 | 0.33 | 0.43 | 0.50 | 0.56 | 0.60 | 0.63 |
| House | 0.13 | 0.33 | 0.44 | 0.51 | 0.56 | 0.59 | 0.62 | 0.63 |
| Bridge | 0.05 | 0.15 | 0.23 | 0.30 | 0.35 | 0.40 | 0.44 | 0.47 |
| Boat | 0.07 | 0.20 | 0.30 | 0.39 | 0.46 | 0.51 | 0.56 | 0.59 |
| Sailboat | 0.06 | 0.18 | 0.28 | 0.36 | 0.42 | 0.47 | 0.52 | 0.55 |
| Couple | 0.09 | 0.26 | 0.40 | 0.50 | 0.56 | 0.61 | 0.64 | 0.66 |
| Crowd | 0.17 | 0.39 | 0.50 | 0.56 | 0.60 | 0.63 | 0.65 | 0.67 |
| Milkdrop | 0.14 | 0.38 | 0.53 | 0.62 | 0.67 | 0.70 | 0.72 | 0.73 |
| Airport | 0.03 | 0.10 | 0.17 | 0.23 | 0.29 | 0.34 | 0.39 | 0.43 |
| Woman | 0.18 | 0.46 | 0.60 | 0.66 | 0.70 | 0.72 | 0.73 | 0.74 |
| Mpic1 | 0.32 | 0.55 | 0.65 | 0.70 | 0.72 | 0.73 | 0.73 | 0.74 |
| Mpic2 | 0.52 | 0.58 | 0.62 | 0.65 | 0.67 | 0.69 | 0.69 | 0.70 |
| Mpic3 | 0.22 | 0.50 | 0.60 | 0.64 | 0.66 | 0.68 | 0.69 | 0.70 |
| Mpic4 | 0.16 | 0.39 | 0.53 | 0.60 | 0.64 | 0.66 | 0.68 | 0.69 |
| Mpic5 | 0.24 | 0.53 | 0.62 | 0.65 | 0.67 | 0.68 | 0.69 | 0.70 |
| Mpic6 | 0.41 | 0.46 | 0.49 | 0.53 | 0.55 | 0.58 | 0.60 | 0.62 |
| Mpic7 | 0.40 | 0.65 | 0.70 | 0.72 | 0.73 | 0.74 | 0.74 | 0.74 |
| Mpic8 | 0.40 | 0.46 | 0.51 | 0.55 | 0.59 | 0.62 | 0.64 | 0.66 |

### Experimental Results in the Companding Embodiment

The inventive method was applied to some frequently used images. Tables 3, 4, 5, and 6 contain the experimental results on four grayscale images, Lena, Baboon, Barbara and Goldhill, respectively. These four images are shown in FIG. 5. Each of these images has a size of 512 pixels by 512 pixels (hereafter 512×512). For a 512×512 image, a payload of 1 bpp (bit per pixel) indicates that 262,144 (namely 512×512) bits are embedded in the image. The data in these tables indicate that the proposed invertible data hiding algorithm can embed a large payload, while maintaining a high PSNR of the marked image versus the original image.

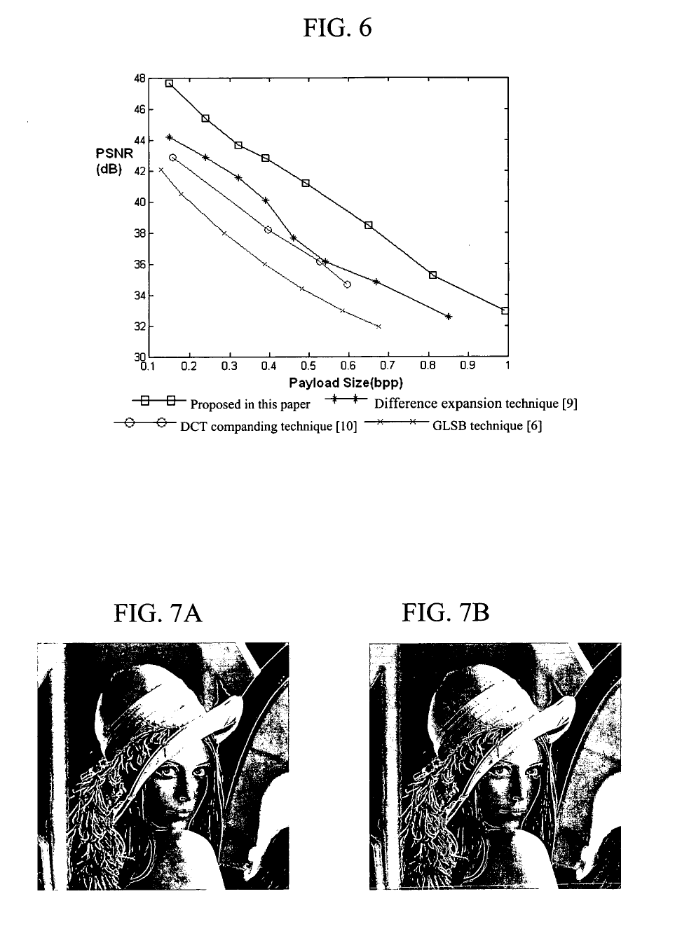

FIG. 6 provides a comparison of results obtained using the present invention to those obtained using prior art approaches: M. Celik, G. Sharma, A. M. Tekalp, and E. Saber, “Reversible data hiding,” Proceedings of the International Conference on Image Processing, Rochester, N.Y., September (2002); J. Tian, “Reversible data embedding using a difference expansion,” IEEE Transactions on Circuits and Systems for Video Technology, August (2003) 890-896; B. Yang, M. Schmucker, W. Funk, C. Busch, and S. Sun, “Integer DCT-based reversible watermarking for images using companding technique,” Proceedings of SPIE Vol. #5306, 5306-41, January 2004. It is observed that the technique described herein obtains the best visual quality at the same payload. From FIG. 6, it appears that the techniques carried out in the wavelet domain (the approach of this application and the difference expansion technique in J. Tian, “Reversible data embedding using a difference expansion,” IEEE Transactions on Circuits and Systems for Video Technology, August (2003) (890-896), which is based on the integer Haar wavelet transform, are superior to the techniques implemented in other domains such as the space domain as shown in M. Celik, G. Sharma, A. M. Tekalp, and E. Saber, “Reversible data hiding,” Proceedings of the International Conference on Image Processing, Rochester, N.Y., September (2002), and the DCT (Discrete Cosine Transform) domain as in B. Yang, M. Schmucker, W. Funk, C. Busch, and S. Sun, “Integer DCT-based reversible watermarking for images using companding technique,” Proceedings of SPIE Vol. #5306, 5306-41, January 2004. This is mostly due to the superior features of the wavelet transform, in particular, visual consistency with the HVS. Besides, it seems that the two-dimensional wavelet transformation (such as CDF(2.2) which is preferred for the method described herein) performs better than one-dimensional wavelet transform (e.g., Haar wavelet used in the difference expansion technique by J. Tian, “Reversible data embedding using a difference expansion,” IEEE Transactions on Circuits and Systems for Video Technology, August (2003) 890-896).

TABLE 3
PSNR vs. payload for Lena image

| | Payload (bpp) | | | | | |
|---|---|---|---|---|---|---|
| | 0.1 | 0.2 | 0.3 | 0.4 | 0.6 | 0.7 |
| PSNR (dB) | 49.53 | 46.23 | 44.04 | 42.28 | 39.43 | 37.48 |

TABLE 4
PSNR vs. payload for Baboon image

| | Payload (bpp) | | | | |
|---|---|---|---|---|---|
| | 0.1 | 0.2 | 0.3 | 0.4 | 0.5 |
| PSN R (dB) | 43.45 | 39.66 | 36.42 | 33.61 | 31.51 |

TABLE 5
PSNR vs. payload for Barbara image

| | Payload (bpp) | | | | | |
|---|---|---|---|---|---|---|
| | 0.1 | 0.2 | 0.3 | 0.4 | 0.5 | 0.6 |
| PSNR (dB) | 49.47 | 46.84 | 44.70 | 42.33 | 40.13 | 36.77 |

TABLE 6
PSNR vs. payload for Goldhill image

| | Payload (bpp) | | | | | |
|---|---|---|---|---|---|---|
| | 0.1 | 0.2 | 0.3 | 0.4 | 0.5 | 0.6 |
| PSNR (dB) | 47.85 | 44.74 | 42.37 | 40.40 | 38.36 | 36.68 |

It should be pointed out that this proposed method can be applied several times in succession on the same image, meaning that we can repeatedly embed data into images that have previously been marked (have data embedded therein) one or more times. Since we preferably embed data into the IWT coefficients of three high frequency subbands, the theoretical upper bound of data embedding capacity is 0.75 bpp each time. The results reported in Tables 3, 4, 5, and 6 arise from a single round of data embedding. For most images, however, a data embedding concentration of 1.3 bpp may be achieved after three successive rounds of data embedding. After that, still more data may be embedded into the marked image, the payload will increase very slowly while the visual quality drops substantially as displayed in FIG. 7.

To further test the validity of the proposed invertible data hiding algorithm, in addition to the above frequently used images, we have applied it to all of the 1096 test images (512×768) in the CorelDraw ® database. Both the payload and PSNR are satisfactory for these images, thus demonstrating the widespread applicability of the proposed scheme.

The desirable results believed to arise from one or more of the following: (1) the superior features of integer wavelet transform, including its high decorrelation among the coefficients, results in a Laplacian-like distribution for high frequency coefficients, which facilitates selection of a suitable compression function; (2) the companding technique makes distortion small between the original image and marked image; and (3) the efficient histogram modification scheme reduces the amount of bookkeeping data. For these reasons, the invertible data hiding technique described herein is preferably applicable to a wide range of uses in areas such as a secure medical image data system, law enforcement, e-government, e-commerce, image authentication and covert communication.

### Threshold Embedding Embodiment

In one or more embodiments, including that disclosed in this section, companding is preferably not employed. Instead, data is preferably embedded only in coefficients small enough such that even when subjected to the embedding formula (x′=2*x+b, where “b” is a single bit placed in the LSB position of the coefficient) the resulting coefficient value does not result in overflow or underflow. In such embodiments, coefficients having absolute values greater than or equal to a specified value, such as T, preferably have no data embedded therein.

In one or more embodiments, a threshold value T is predefined. Different embedding rules may be applied to high frequency wavelet coefficients based on whether the coefficient is (a) smaller than T, (b) equal to T, or (c) larger than T. Herein, the term “high frequency wavelet coefficients” generally refers to IWT coefficients of high frequency sub-bands such as the HL, LH, and HH subbands.

Data Hiding

In one or more embodiments, to embed data into a high frequency coefficient x, the absolute value of the coefficient may be compared with T. If |x|<T, the coefficient value may be doubled, and a payload data bit may be embedded into the LSB position of the coefficient that is left empty after the doubling of the coefficient value. Otherwise stated, the binary representation of the coefficient value may be shifted towards left by one bit, and the to-be-embedded bit may be appended as the right-most bit. The resultant coefficient is denoted by x′.

Where x≧T, the value of T may be added to the coefficient. Where x≦−T, the value of T−1 may be subtracted from the coefficient. In one or more embodiments, in either of the cases where the absolute value of x exceeds the value of T, no bit is embedded into the coefficient. These rules are summarized in Equation (8). In the first line of equation (8) below, the symbol in between “2” and “x” corresponds to multiplication. Thus, the first line of equation (8) below recites the equation 2*x+b.

$${x}^{′} = \{ \begin{matrix}2 • x + b , & if \vert x \vert < T \\ x + T , & if x \geq T \\ x - ( T - 1 ) , & if x \leq - T\end{matrix} \qquad ( 8 )$$

Hidden Data Extraction and Original Image Restoration

In one or more embodiments, in the data extraction stage, the IWT coefficients of the marked image are obtained by subjecting the marked pixel domain image to an integer wavelet transform. If a coefficient is less then 2T and larger than (−2T+1), the LSB of the coefficient is the data bit embedded in the coefficient.

Where the coefficient is outside this range, the data extraction method preferably concludes, consistent with the data embedding formula (8), that no payload data bit is embedded in the coefficient, and therefore, preferably does not attempt to extract a data bit from the coefficient. After deciding not to extract a data bit, one or more embodiments of the data extraction method preferably proceed to examine the next coefficient, since the current coefficient has no hidden bit in it. However, the method may first restore the current coefficient to its original value.

In addition to extracting hidden data, the data extraction method preferably also recovers the original cover image. Preferably, each coefficient is restored to its original value by applying equation (9).

$$x = \{ \begin{matrix}⌊ {x}^{′} / 2 ⌋ , & if & - 2 T + 1 < {x}^{′} < 2 T \\ {x}^{′} - T , & if & {x}^{′} \geq 2 T \\ {x}^{′} + T - 1 , & if & {x}^{′} \leq - 2 T - 1\end{matrix} . \qquad ( 9 )$$

The symbol surrounding the expression x′/2 is explained as follows: └y┘ takes the largest integer value that is smaller than y. This principle is readily applicable to the expression x′/2 in formula (9) above. In one or more embodiments, when applying formula (9) to divide x′ by 2 is effective in restoring the original value of x.

Table 7 lists the data associated with embedding data into four coefficients, with one coefficient having a 0 bit embedded therein, another coefficient having a 1 bit embedded therein, and two coefficients receiving no embedded data. In the example of Table 7, T is set equal to 6. Verification of the embedding formula, the data extraction formula, and the recovery of original coefficients is easily accomplished in the illustrated example.

TABLE 7
Embed bits 0, and 1 into coefficients [3, 5, 9, −7] with T = 6.

| | Original | | Hidden | Marked |
|---|---|---|---|---|
| Order | value | Greater than T? | data [0,1] | value |
| 1 | 3 | No | 0 | 6 |
| 2 | 5 | No | 1 | 11 |
| 3 | 9 | Yes | — | 15 |
| 4 | −7 | Yes | — | −12 |

Data Hiding System

In one or more embodiments, the proposed lossless data hiding scheme may embed data into the first-level high-frequency subbands of images, namely, HL₁, LH₁ and HH₁ (see FIG. 3A).

FIG. 8 is a flow diagram of a method 800 for embedding data in an image in accordance with one or more embodiments of the present invention. At step 802, histogram modification may be performed to ensure that no overflow/underflow occurs. Bookkeeping data describing the histogram modification is preferably preserved. At step 804, an integer wavelet transform may be performed that converts the image from the pixel domain into the wavelet domain. At step 806, payload data is preferably embedded into selected subbands as discussed in detail above. Histogram modification information may also be incorporated into coefficients within selected high frequency sub-bands in step 806. At step 808, an inverse wavelet transform is preferably performed on the wavelet domain data, which includes embedded data, to provide a marked image.

FIG. 9 is a flow diagram of a method 900 for extracting data from an image in accordance with one or more embodiments of the present invention. At step 902, the marked image produced by the method of FIG. 8 preferably undergoes an integer wavelet transform. At step 904 payload data is preferably extracted from sub-bands within the wavelet domain that contain embedded data. Further, information on histogram modification is preferably also extracted from selected sub-bands (for use in step 908).

At step 906, an inverse wavelet transform is preferably performed on the wavelet domain data which is, at this point, preferably free of the embedded data extracted in step 904. At step 908 an inverse histogram modification is preferably performed using the histogram modification information performed in step 904, thereby recovering the original image that the method of FIG. 8 was performed on.

### Results for the Threshold Embedding Embodiment

Herein, the term “high frequency coefficients” refers to the coefficients in the HL, LH or, HH sub-bands. Herein, the sub-band identifiers HL, LH, and HH are used interchangeably with the labels HL₁, LH₁, and HH₁, respectively.

For most images, the distribution of high frequency coefficients of the integer wavelet transform has a Laplacian-like distribution (see FIG. 3B). Thus, most high frequency integer wavelet transform coefficients have a very small magnitude. Since the high frequency coefficients in the HL, LH, and HH sub-bands comprise 75% of all IWT coefficients, and it is generally possible to embed one bit into each coefficient, the highest possible payload is 0.75 bit per pixel (bpp). For the Lena image, if the threshold T is set equal to 8, the resulting payload is 0.68 bpp. This result indicates that over 90% of the coefficients in the high frequency subbands are used for data hiding (0.68/0.75=0.9067). Table 8 lists the payload per pixel of the Lena image arising using various Threshold values.

TABLE 8
Threshold vs. payload for Lena image.

| T = 4 | T = 6 | T = 8 |
|---|---|---|
| 0.50 bpp | 0.62 bpp | 0.68 bpp |

Generally, the larger the threshold T is, the higher the payload will be. However, on the other hand, the larger the threshold T, the lower the PSNR (peak signal noise ratio) will be. The foregoing applies to a substantial range of data hiding techniques. Thus, payload and PSNR are competing characteristics.

FIG. 10 shows plots of PSNR versus payload size for a method in accordance with one or more embodiments of the present invention and for three existing lossless data hiding methods. In the graph of FIG. 10, the curve identified in the legend with the text “Threshold Embedding Based on IWT” is the method described herein. The curve identified with the text “Bitplane Compression” is the method reported in G. Xuan, J. Zhu, J. Chen, Y. Q. Shi, Z. Ni and W. Su, “Distortionless data hiding based on integer wavelet transform,” IEE Electronics Letters, December (2002) 1646-1648. The curve identified with the text “Difference Expansion” is the method reported in J. Tian, “Reversible data embedding using a difference expansion,” IEEE Transactions on Circuits and Systems for Video Technology, August (2003) 890-896. The curve identified with the text “Spread Spectrum” is reported in G. Xuan, Y. Q. Shi, Z. Ni, “Lossless data hiding using integer wavelet transform and spread spectrum,” IEEE International Workshop on Multimedia Signal Processing, Siena, Italy, September 2004. The graph of FIG. 10 illustrates that, for a given payload size, the method described herein boasts the highest PSNR of all the methods compared in FIG. 10. Specifically, for a payload of 0.5 bpp, the lossless data hiding algorithm disclosed herein boasts a PSNR that is 4 db higher than the best performing existing approach. It is noted that the results shown in FIG. 15 are for a single occurrence of data embedding.

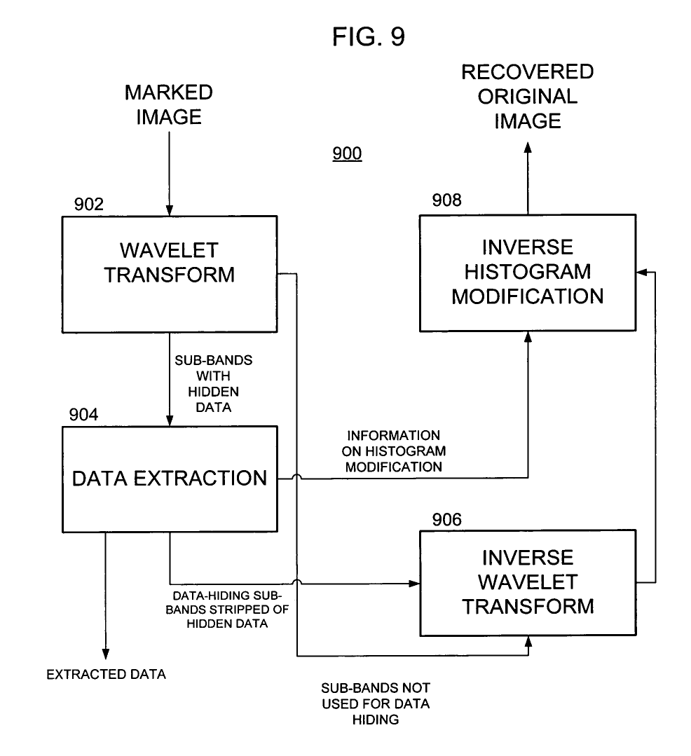

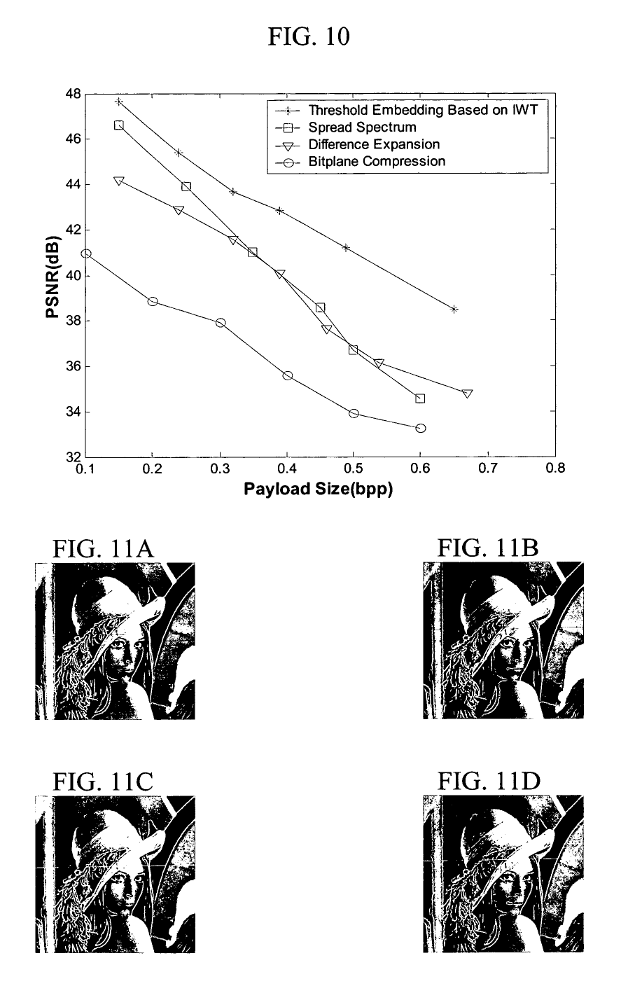

To further improve the data payload of an image, the data embedding process may be repeated several times in succession, in each case (except for the first time) starting with an image (stego-image) that has already been marked (had data embedded therein) one or more times. By applying the same embedding procedure to the stego-images, the payload can be increased. The drawback is the decrease of PSNR, which corresponds to a deterioration in image quality. FIG. 11A shows the original Lena image. FIGS. 11B-D show the Lena image with a progressively increasing number of occurrences of data embedding having been performed thereon. In FIG. 11D, which shows the Lena image with three successive occurrences of data embedding, the visual quality of the marked image shows substantial deterioration, and visual artifacts are visible.

Histogram Modification:

For a given image, after data are embedded into some IWT (Integer Wavelet Transform) coefficients, it is possible to cause overflow and/or underflow. This means that after the inverse integer wavelet transform is performed, the grayscale values of some pixels in the marked image may exceed the upper bound (the upper bound being 255 for an eight-bit grayscale image) or the lower bound (the lower bound being 0 for an eight-bit grayscale image). In this situation, truncation is generally applied to restore the resulting grayscale value to a permissible numerical range, thereby violating the reversibility of the data hiding. This is a challenging issue confronting all lossless data hiding algorithms.

In one or more embodiments of the present invention, in order to prevent overflow and/or underflow, a histogram modification procedure may be adopted which narrows the range of histograms of pixel-domain images from both the left and right sides. Preferably, after the histogram modification, some grayscale values on the left-hand side of the histogram are merged towards the center of the histogram and left empty, while some grayscale values from the right-hand side are merged towards the center of the histogram and left empty. In the following discussion, it is assumed that we are going to narrow a histogram by G grayscale levels, which means that G grayscale values should be empty after the histogram is modified.

For the sake of simplicity, in this section, G is restricted to being an even number. Thus we can narrow down the histogram in G/2 passes, and in each pass the histogram is preferably narrowed down by two grayscale levels, one from the left-hand side, the other from the right-hand side. In narrowing down a histogram to the range [G/2, 255−G/2], (See FIG. 12) the histogram modification information is preferably recorded as bookkeeping data and preferably embedded into the image. The data to be embedded into the image therefore may arise from two or more sources: 1) the watermark signal (payload data); and 2) the bookkeeping data of histogram modification. As discussed later in this document, an additional possible source of embedded data is compression recording data which may be employed to store information about signal compression occurring within the integer wavelet domain.

A Simplified Histogram Modification Example:

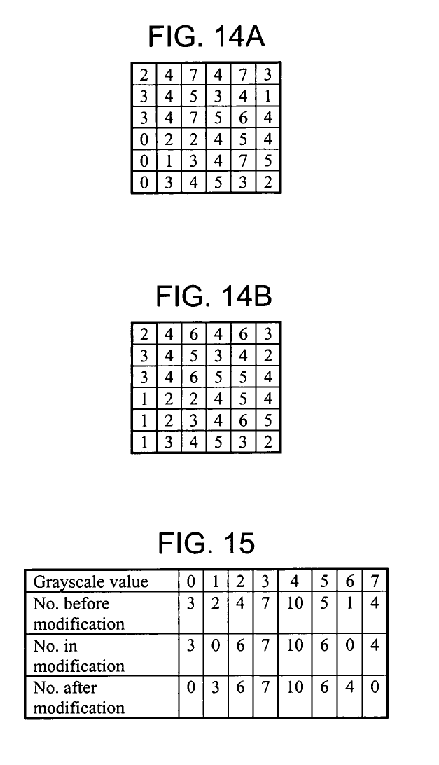

In order to illustrate the histogram narrow-down process, we use a simplified example, where the original image has a size of 6×6 pixels, each pixel having 2³=8 possible gray scale values (the values ranging from 0 to 7) as shown in FIGS. 13-14. From FIGS. 13-15, it can be seen that the range of the modified histogram now is from 1-6 instead of 0-7. Specifically, no pixel has a grayscale value of either 0 or 7. After modification, grayscale value 1 is merged into grayscale value 2, and grayscale value 0 is merged into grayscale value 1. In the same way, grayscale value 6 is merged into grayscale value 5, and Grayscale value 7 becomes grayscale value 6. The original and modified histograms are shown in FIG. 12. An illustration of pixels in a sample image before and after histogram modification are shown in FIGS. 13A and 13B, respectively. Data corresponding to the pixel grayscale values illustrated in FIGS. 13A and 13B are shown in FIGS. 14A and 14B, respectively. Data describing the original and modified histograms are shown in FIG. 15.

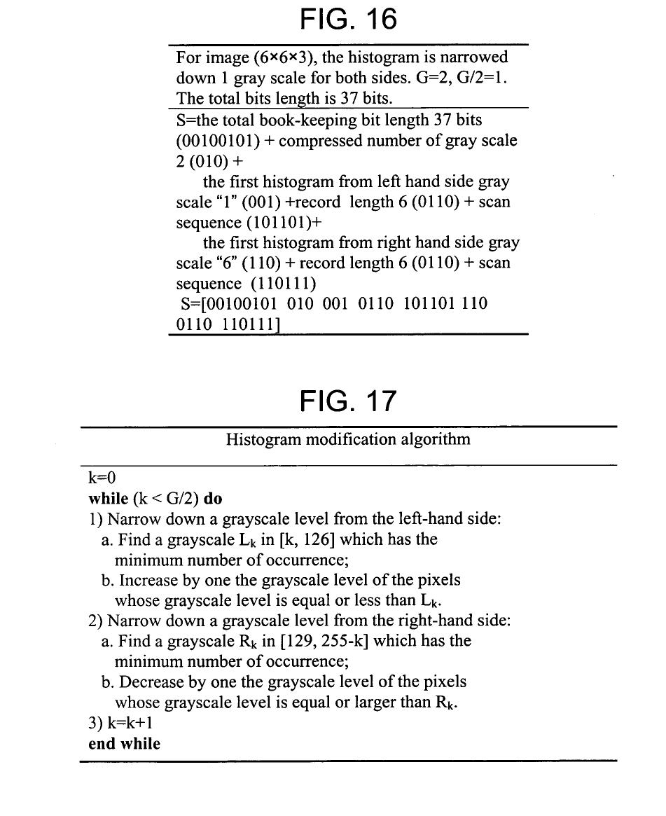

FIG. 16 shows bookkeeping data which may be used to describe the histogram modification illustrated in FIG. 12. The left-hand side record bits with its left neighbor grayscale value (101101) in FIG. 16 show that both the second and fifth values of “2” by scanning (<x=5,y=1>,<(x=1,y=4>) in FIG. 14B have values of “1” in FIG. 14A originally. Moreover, the right-hand side record bits with its right neighbor grayscale value (110111) in FIG. 17 shows that the third “5” by scanning (<x=4,y=2>) in FIG. 14B has the value “6” in FIG. 14A.

One embodiment of a histogram narrowing algorithm is described in FIG. 17. In narrowing down a histogram to the range [G/2, 255−G/2], it is beneficial to record the histogram modification information such as the grayscale values that are merged (Lₖ and Rₖ in FIG. 17) and the position of pixels whose grayscale values are equal to Lₖ or Rₖ. and which are a part of the embedded data. This recorded information is referred to herein as bookkeeping data. Preferably, the original image can be losslessly restored using the recorded bookkeeping data. Generally speaking, the amount of bookkeeping data is small.

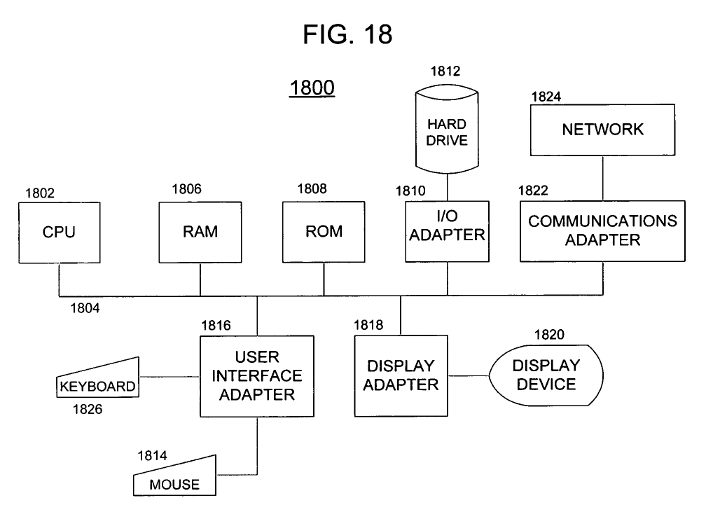

FIG. 18 is a block diagram of a computing system 1800 adaptable for use with one or more embodiments of the present invention. In one or more embodiments, central processing unit (CPU) 1802 may be coupled to bus 1804. In addition, bus 1804 may be coupled to random access memory (RAM) 1806, read only memory (ROM) 1808, input/output (I/O) adapter 1810, communications adapter 1822, user interface adapter 1816, and display adapter 1818.

In one or more embodiments, RAM 1806 and/or ROM 1808 may hold user data, system data, and/or programs. I/O adapter 1810 may connect storage devices, such as hard drive 1812, a CD-ROM (not shown), or other mass storage device to computing system 1800. Communications adapter 1822 may couple computing system 1800 to a local, wide-area, or Internet network 1824. User interface adapter 1816 may couple user input devices, such as keyboard 1826 and/or pointing device 1814, to computing system 1800. Moreover, display adapter 1818 may be driven by CPU 1802 to control the display on display device 1820. CPU 1802 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### REFERENCES

J. M. Barton, “Method and apparatus for embedding authentication information within digital data,” U.S. Pat. No. 5,646,997, 1997.
C. W. Honsinger, P. Jones, M. Rabbani, and J. C. Stoffel, “Lossless recovery of an original image containing embedded data,” U.S. Pat. No. 6,278,791, 2001.
J. Fridrich, M. Goljan and R. Du, “Invertible authentication,” Proc. SPIE Photonics West, Security and Watermarking of Multimedia Contents III, Vol. 397, pp. 197-208, San Jose, Calif., January 2001.
M. Goljan, J. Fridrich, and R. Du, “Distortion-free data embedding,” Proceedings of 4^{th} Information Hiding Workshop, pp. 27-41, Pittsburgh, Pa., April 2001.
C. De Vleeschouwer, J. F. Delaigle and B. Macq, “Circular interpretation of bijective transformations in lossless watermarking for media asset management,” IEEE Tran. Multimedia, vol. 5, pp. 97-105, March 2003.
M. Celik, G. Sharma, A. M. Tekalp, and E. Saber, “Reversible data hiding,” Proceedings of the International Conference on Image Processing, Rochester, N.Y., September (2002).
G. Xuan, J. Zhu, J. Chen, Y. Q. Shi, Z. Ni and W. Su, “Distortionless data hiding based on integer wavelet transform,” IEE Electronics Letters, December (2002) 1646-1648.
Z. Ni, Y. Q. Shi, N. Ansari and W. Su, “Reversible data hiding,” Proceedings of IEEE International Symposium on Circuits and Systems, Bangkok, Thailand, May 2003.
J. Tian, “Reversible data embedding using a difference expansion,” IEEE Transactions on Circuits and Systems for Video Technology, August (2003) 890-896.
B. Yang, M. Schmucker, W. Funk, C. Busch, and S. Sun, “Integer DCT-based reversible watermarking for images using companding technique,” Proceedings of SPIE Vol. #5306, 5306-41, January 2004.
G. Xuan, Y. Q. Shi, Z. C. Ni, J. Chen, C. Yang, Y. Zhen, J. Zheng, “High capacity lossless data hiding based on integer wavelet transform,” Proceedings of IEEE 2004 International Symposium on Circuits and Systems, vol. II, pp. 29-32, May 2004, Vancouver, Canada.
B. Sklar, Digital Communications: Fundamentals and Applications. Englewood Cliffs, N.J.: PTR Prentice Hall (1988).
A. R. Calderbank, I. Daubechies, W. Sweldens, B. -L. Yeo, “Wavelet transforms that map integers to integers,” In: Applied and Computational Harmonic Analysis, July (1998) 332-369.
M. Rabbani and R. Joshi, “An Overview of the JPEG2000 Still Image Compression Standard”, Signal Processing: Image Communication 17 (2002) 3-48.
Y. Q. Shi, Z. Ni, D. Zou, C. Liang and G. Xuan, “Lossless data hiding: Fundamentals, algorithms and applications,” Proceedings of IEEE International Symposium on Circuits and Systems, vol. 11, pp.33-36, Vancouver, Canada, May 2004.
Y. Q. Shi, “Reversible data hiding,” Proceedings of International Workshop on Digital Watermarking, Seoul, Korea, Oct. 1 to Nov. 2, 2004.
A. Leest, M. Veen, and F. Bruekers, “Reversible image watermarking,” Proc. of IEEE ICIP, vol. 2, pp. 731-734, September 2003.
G. Xuan, Y. Q. Shi, Z. Ni, “Lossless data hiding using integer wavelet transform and spread spectrum,” IEEE International Workshop on Multimedia Signal Processing, Siena, Italy, September 2004.
www.corel.com.

1. A method, comprising:
subjecting an original, pixel domain image to an Integer Wavelet Transform (IWT) to obtain a first matrix of IWT coefficients;
multiplying selected ones of said IWT coefficients by two; and
embedding a data bit in a LSB (Least Significant Bit) position of each said selected coefficient, thereby providing a marked image.

2. The method of claim 1 wherein said selected IWT coefficients are selected from at least one frequency sub-band of said matrix of IWT coefficients.

3. The method of claim 2 wherein said at least one frequency sub-band comprises at least one frequency sub-band selected from the group consisting of: an HL sub-band, an LH sub-band, and an HH sub-band.

4. The method of claim 1 further comprising:
narrowing a histogram of said original image prior to said multiplying.

5. The method of claim 4 further comprising:
recording said narrowing of said histogram with histogram modification data; and
embedding said histogram modification data in said image.

6. The method of claim 1 further comprising:
applying a compression function to said first matrix of IWT coefficients to provide a second matrix of compressed IWT coefficients.

7. The method of claim 6 wherein said compression function is a piecewise linear function, and wherein the method further comprises:
quantizing said piecewise linear function to provide:
a) a first segment of said quantized piecewise linear function having a one-to-one mapping between a first group of said IWT coefficients within said first matrix and a first group of said compressed IWT coefficients within said second matrix; and
b) a second segment of said quantized piecewise linear function having a many-to-one mapping between a second group of said IWT coefficients within said first matrix and a second group of said IWT coefficients within said second matrix.

8. The method of claim 7 further comprising:
generating compression recording data enabling reversing said many-to-one mapping in said second segment of said quantized piecewise linear function; and
storing said compression recording data in said IWT coefficients of said second matrix.

9. The method of claim 7 wherein said one-to-one mapping in said first segment of said quantized piecewise linear function is implemented employing the function F(x)=x.

10. The method of claim 1 wherein said multiplying step comprises:
multiplying by two only those IWT coefficients that have absolute values less than a threshold value (T).

11. The method of claim 10 further comprising:
selecting a value of T by a human operator.

12. The method of claim 10 further comprising:
selecting a value of T employing a software program running on a computer.

13. The method of claim 10 further comprising:
adding T to IWT coefficients having values greater than or equal to T.

14. The method of claim 10 further comprising:
subtracting the value (T−1) from IWT coefficients having values less than or equal to −T.

15. An apparatus including a processor operating under the instructions of a software program, the software program causing the apparatus to perform actions, comprising:
subjecting an original, pixel domain image to an Integer Wavelet Transform (IWT) to obtain a matrix of IWT coefficients;
multiplying selected ones of said IWT coefficients by two; and
embedding a data bit in a LSB (Least Significant Bit) position of each said selected coefficient, thereby providing a marked image.

16. A storage medium containing a software program operable to cause an apparatus including a processor under the instructions of the software program to perform actions, comprising:
subjecting an original, pixel domain image to an Integer Wavelet Transform (IWT) to obtain a matrix of IWT coefficients;
multiplying selected ones of said IWT coefficients by two; and
embedding a data bit in a LSB (Least Significant Bit) position of each said selected coefficient, thereby providing a marked image.

17. A method, comprising:
subjecting a marked pixel domain image to an Integer Wavelet Transform (IWT) to obtain a first matrix of IWT coefficients;
identifying coefficients in said matrix that contain embedded payload data; and
extracting data bits from LSB positions of said identified coefficients.

18. The method of claim 17 further comprising:
dividing said identified coefficients by two to restore a value of said coefficients in existence prior to an introduction therein of said embedded payload data.

19. The method of claim 17 further comprising:
extracting histogram modification data from said first matrix of wavelet coefficients, said histogram modification data describing a modification of a histogram of an original version of said marked pixel domain image.

20. The method of claim 19 further comprising:
subjecting said matrix of IWT coefficients to an inverse integer wavelet transform to obtain an unmarked pixel domain image; and
modifying a histogram of said unmarked pixel-domain image using said histogram modification data to provide said original pixel-domain image.

21. The method of claim 17 further comprising:
applying an expansion function to said IWT coefficients of said first matrix to provide expanded IWT coefficients in a second matrix of IWT coefficients.

22. The method of claim 21 wherein said expansion function is a quantized piecewise linear function comprising:
a first segment of said quantized piecewise linear function having a one-to-one mapping between a first group of said IWT coefficients of said first matrix and a first group of said expanded IWT coefficients of said second matrix; and
a second segment of said quantized piecewise linear function having a one-to-many mapping between a second group of said IWT coefficients of said first matrix and a second group of said IWT coefficients of said second matrix.

23. The method of claim 22 further comprising:
extracting compression recording data from said IWT coefficients of said first matrix; and
using said extracted compression recording data to conduct said one-to-many mapping of said second segment of said quantized piecewise linear function.

24. The method of claim 17 further comprising:
subtracting a threshold value (T) from IWT coefficients having values greater than or equal to 2T.

25. The method of claim 17 further comprising:
adding the value (T−1) to IWT coefficients having values less than or equal to 2T−1.

26. An apparatus including a processor operating under the instructions of a software program, the software program causing the apparatus to perform actions, comprising:
subjecting a marked pixel domain image to an Integer Wavelet Transform (IWT) to obtain a matrix of wavelet coefficients;
identifying coefficients in said matrix that contain embedded payload data; and
extracting data bits from LSB positions of said identified coefficients.

27. A storage medium containing a software program operable to cause an apparatus including a processor under the instructions of the software program to perform actions, comprising:
subjecting a marked pixel domain image to an Integer Wavelet Transform (IWT) to obtain a matrix of wavelet coefficients;
identifying coefficients in said matrix that contain embedded payload data; and
extracting data bits from LSB positions of said identified coefficients.

28. A method, comprising:
subjecting an original, pixel domain image to an Integer Wavelet Transform (IWT) to obtain a matrix of IWT coefficients located within a plurality of frequency sub-bands;
selecting at least one of said sub-bands;
embedding a payload data bit only in coefficients within said selected at least one sub-band whose absolute values are less than a threshold (T).

29. The method of claim 28 wherein said embedding step comprises:
multiplying by two said coefficients having absolute values less than T; and
placing said payload data bits in respective LSB (least significant bit) positions of said multiplied coefficients.

30. The method of claim 28 wherein said selecting comprises:
selecting said at least one sub-band from the group consisting of: an HL sub-band, an LH sub-band, and an HH sub-band.

31. An apparatus including a processor operating under the instructions of a software program, the software program causing the apparatus to perform actions, comprising:
subjecting an original, pixel domain image to an Integer Wavelet Transform (IWT) to obtain a matrix of IWT coefficients located within a plurality of frequency sub-bands;
selecting at least one of said sub-bands;
embedding a payload data bit only in coefficients within said selected at least one sub-band whose absolute values are less than a threshold (T).

32. A storage medium containing a software program operable to cause an apparatus including a processor under the instructions of the software program to perform actions, comprising:
subjecting an original, pixel domain image to an Integer Wavelet Transform (IWT) to obtain a matrix of IWT coefficients located within a plurality of frequency sub-bands;
selecting at least one of said sub-bands;
embedding a payload data bit only in coefficients within said selected at least one sub-band whose absolute values are less than a threshold (T).
